(19) United States
(12) Patent Application Publication
(10) Pub. No.: US 2024/0141991 A1
(43) Pub. Date: May 2, 2024

(54) PARKING BRAKE ACTUATOR

(71) Applicant: RAICAM DRIVELINE S.R.L., Mondovì (Cuneo) (IT)

(72) Inventors: David CHILD, Leamington Spa, Warwickshire (GB); Keith HOMAN, Kidderminster, Worcestershire (GB); Benjamin Chetwood STRUVE', Kenilworth, Warwickshire (GB)

(21) Appl. No.: 18/547,117

(22) PCT Filed: Feb. 21, 2022
(86) PCT No.: PCT/EP2022/054199

§ 371 Date: Aug. 18, 2023

(30) Foreign Application Priority Data
Feb. 22, 2021 (IT) 102021000004052

(51) Int. Cl. F16H 63/34; B60T 1/00; B60T 13/22

(52) U.S. Cl. CPC F16H 63/3483; B60T 1/005; B60T 13/22; F16H 63/345

(57) ABSTRACT

A parking brake system for vehicles, in particular heavy-duty vehicles, is provided. The parking brake system has a parking brake actuator having an actuation pushrod slidably housed within an actuator cylinder and adapted to act on a release mechanism of a vehicle brake for unlocking the vehicle brake, and a hydraulic pump operated by an electric motor, adapted to deliver a flow of fluid into the actuator cylinder for moving the actuation pushrod.

### TECHNICAL FIELD

This invention relates, in general, to the brake sector; in particular, the invention relates to a parking brake actuator for a vehicle (e.g., a heavy duty vehicle) and a parking brake system comprising such parking brake actuator, in particular for tractors.

### SUMMARY OF THE INVENTION

Agricultural tractors often use a transmission brake for locking the vehicle in place when parked.

The brake is usually wet, and is incorporated within the transmission housing, before the differential.

This gives some advantages which are relevant to this type of vehicle, e.g. it is enclosed, and safely contained away from mud, dirt and water, and its enclosure ensures that corrosion is not a problem if the vehicle is left parked for long periods of time.

The design of brake is traditionally similar to that illustrated in FIG. 1, wherein a multidisc brake is shown, which is hydraulically operated and activated by a lack of pressure.

A Belleville spring exerts a force on a piston, which presses on the fixed and mobile discs of the brake and immobilizes the shaft.

When the brake has to be unlocked, a flow of pressurized fluid is entered into a duct communicating with the piston, so as to exert a thrust on the latter against the Belleville spring, up to the mutual disengagement of the brake discs.

A system like this has the advantage of being fail-safe, indeed when the vehicle is not operating or the hydraulic circuit fails, the brake locks and the vehicle is immobile.

However, the disadvantage of a hydraulically released brake is that it can only be applied to larger tractors which have high pressure and centralized hydraulic systems.

An object of the invention is to overcome the aforementioned limitation.

In order to provide the user with the advantages of a powered parking brake release system for all heavy-duty vehicles (and tractors in particular), there is proposed a linear actuator adapted to operate a spring applied, lever released parking brake.

In particular, a parking brake actuator for vehicles (such as heavy-duty vehicles or tractors), according to the invention, comprises an actuator cylinder, a piston slidably housed within the latter and an actuation pushrod 14, integrally connected to such piston and having an end projecting outside of the actuator cylinder, which end is adapted to act on a release mechanism of a vehicle brake (e.g., a multidisc brake for a tractor) for unlocking it.

The aforesaid and other objects and advantages are achieved, according to an aspect of the invention, by a parking brake actuator having the features defined in claim 1. Preferred embodiments of the invention are defined in the dependent claims.

### BRIEF DESCRIPTION OF THE DRAWINGS

The functional and structural features of some preferred embodiments of a parking brake actuator and system according to the invention will now be described. Reference is made to the accompanying drawings, wherein:

FIG. 1 is a schematic side view of a release mechanism for a multidisc brake for a tractor, according to the prior art;

FIG. 2 is a schematic diagram of a release mechanism for a multidisc brake operated by a parking brake actuator according to an embodiment of the invention;

FIG. 3 is a hydraulic scheme of a parking brake system incorporating the parking brake actuator, according to an embodiment of the invention;

FIGS. 4 to 6 are a perspective, side and exploded views of a parking brake system according to an embodiment of the invention, respectively;

FIG. 7A is a schematic sectional view of a piston of the parking brake system equipped with a pressure relief valve;

FIG. 7B is a schematic perspective view in transparency of a body of the parking brake system in FIGS. 4 to 6;

FIGS. 8 and 9 are schematic diagrams of a hydraulic pump included in the parking brake system, according to an embodiment of the invention;

FIGS. 10 and 11 are schematic diagrams of a solenoid valve included in the parking brake system, according to an embodiment of the invention;

FIGS. 12 and 13 are schematic diagrams of a solenoid valve included in the parking brake system, according to an alternative embodiment of the invention;

FIGS. 14 to 17 are hydraulic schemes illustrating the parking brake system acting on a release mechanism of a multidisc brake, according to an operation mode of the invention; and

FIGS. 18 to 20 are hydraulic schemes illustrating the parking brake system acting on a release mechanism of a multidisc brake, according to an alternative operation mode of the invention.

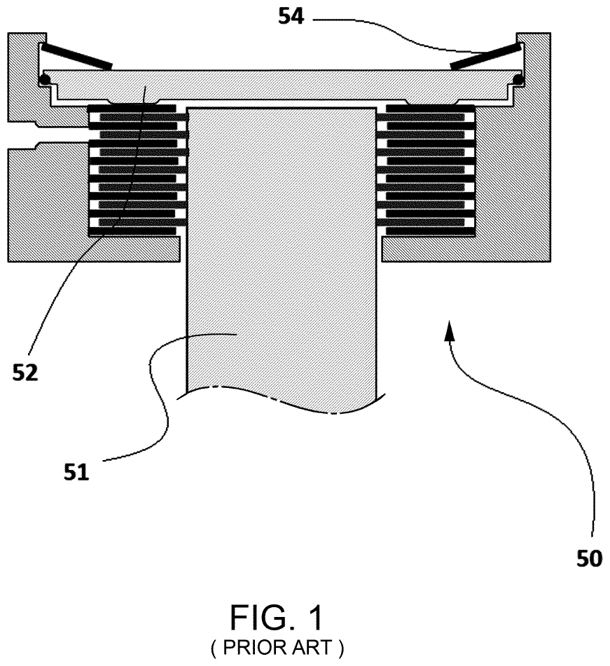

### DETAILED DESCRIPTION

Before describing in detail a plurality of embodiments of the invention, it should be clarified that the invention is not limited in its application to the construction details and configuration of the components presented in the following description or illustrated in the drawings. The invention may assume other embodiments and be implemented or constructed in practice in different ways. It should also be understood that the phraseology and terminology have a descriptive purpose and should not be construed as limiting.

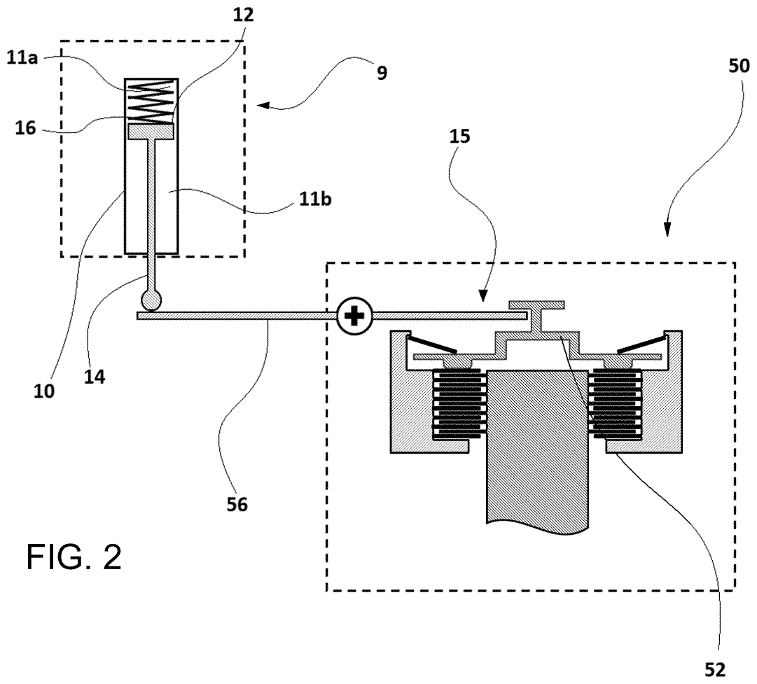

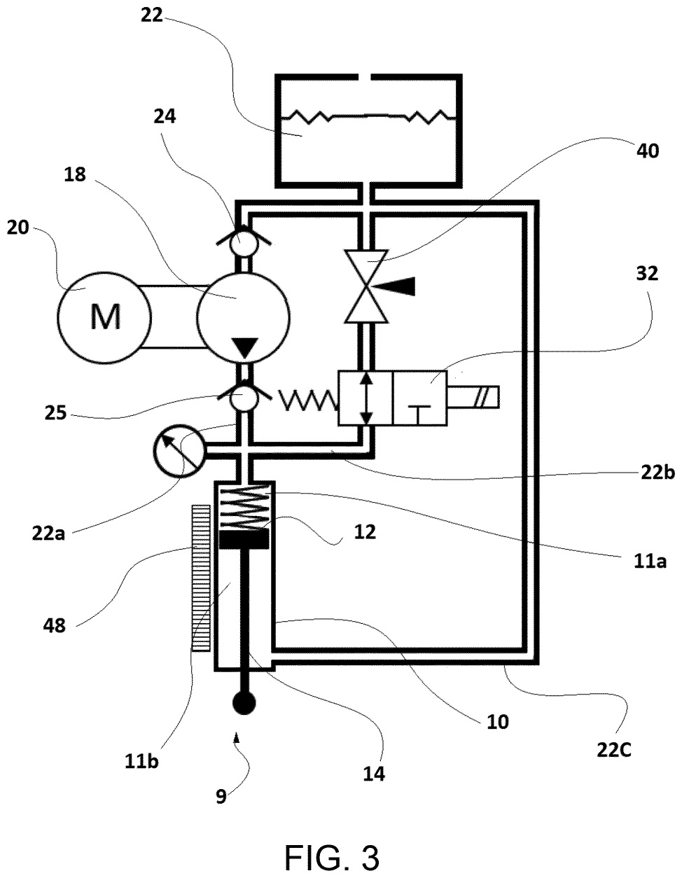

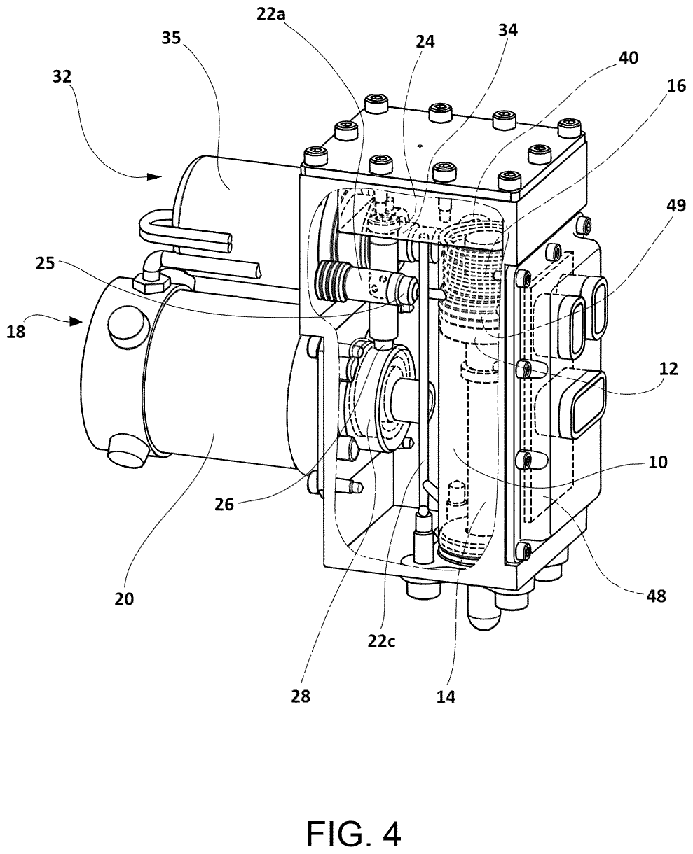

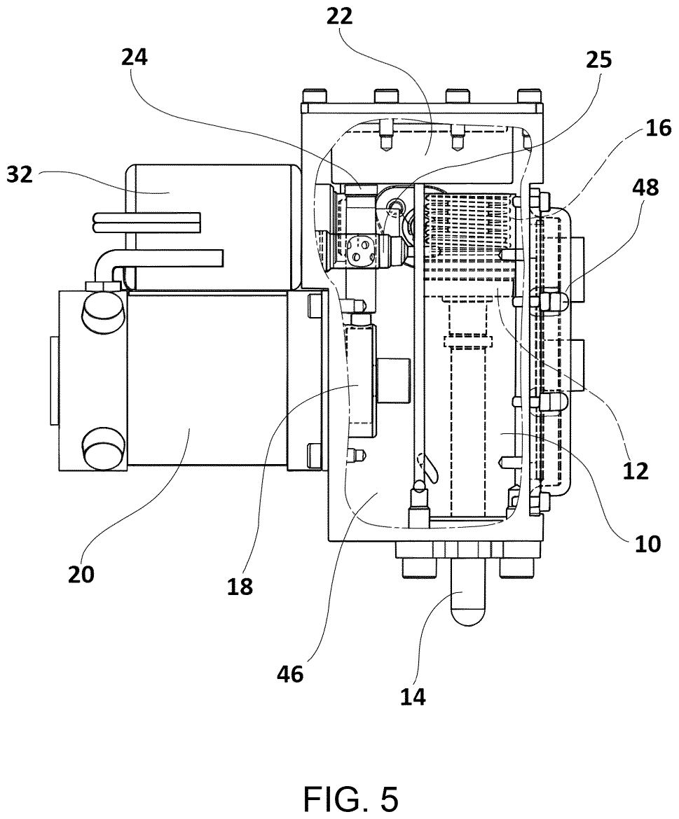

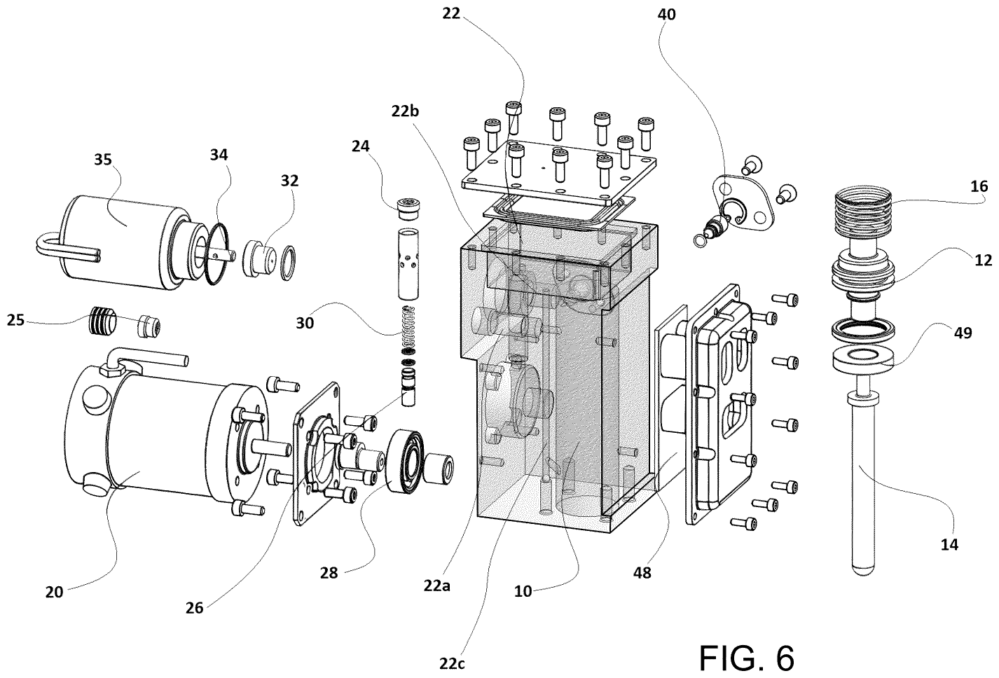

Referring by way of example to FIG. 2, a parking brake system for vehicles, in particular heavy duty vehicles, and more in particular tractors, comprises a parking brake actuator 9 which comprises an actuator cylinder 10, and a piston 12, which is slidably housed within the actuator cylinder 10 and divides the internal volume of said actuator cylinder 10 into an upper chamber 11a, in fluid communication with the exterior of the actuator cylinder 10, and a lower chamber 11b.

The piston 12 is axially slidable within the actuator cylinder 10 in response to a flow of fluid entering into the upper chamber 11a.

The parking brake actuator 9 further comprises an actuation pushrod 14, slidably housed within the lower chamber 11b of the actuator cylinder 10. The actuation pushrod 14 is integrally connected to, and integrally movable with, the piston 12 and has an end projecting outside of the actuator cylinder 10, said end of the actuation pushrod 14 being adapted to act on a release mechanism 15 of a vehicle brake (in particular, a multidisc brake for tractors) for unlocking the latter.

The parking brake system further comprises a hydraulic pump 18 operated by an electric motor 20, said hydraulic pump 18 being adapted to deliver a flow of fluid into the upper chamber 11a for moving the piston 12 within the actuator cylinder 10.

According to a preferred embodiment, a hydraulic reservoir 22, adapted to contain a working fluid to be delivered into the actuator cylinder 10, and a delivery duct 22a, which puts in fluid communication said hydraulic reservoir 22 with the upper chamber 11a of the actuator cylinder 10, are provided, wherein the outlet section of the hydraulic pump 18 is hydraulically connected to such delivery duct 22a downstream of the hydraulic reservoir 22. The parking brake system further comprises a one-way intake valve 24 and a one-way exhaust valve 25, placed on the delivery duct 22a upstream and downstream of the outlet section of the pump 18, respectively, and arranged for allowing a fluid to flow only from the hydraulic reservoir 22 to the upper chamber 11a of the actuator cylinder 10 when the hydraulic pump 18 is operated. In particular, the intake valve 24 is configured for opening a passage for the fluid from the reservoir 22 to the hydraulic pump 18 only in response to the latter creating a depression downstream of such intake valve 24, and the exhaust valve 25 is configured for opening a passage for the fluid the hydraulic pump 18 to the upper chamber 11a of the actuator cylinder 10 only in response to the pump 18 delivering the fluid towards the actuator cylinder 10, which results in a pressure increase upstream of such exhaust valve 25.

The hydraulic pump 18 may be of any suitable type known to a person with an average skill in the art, e.g. it may be a conventional gerotor or gear pump.

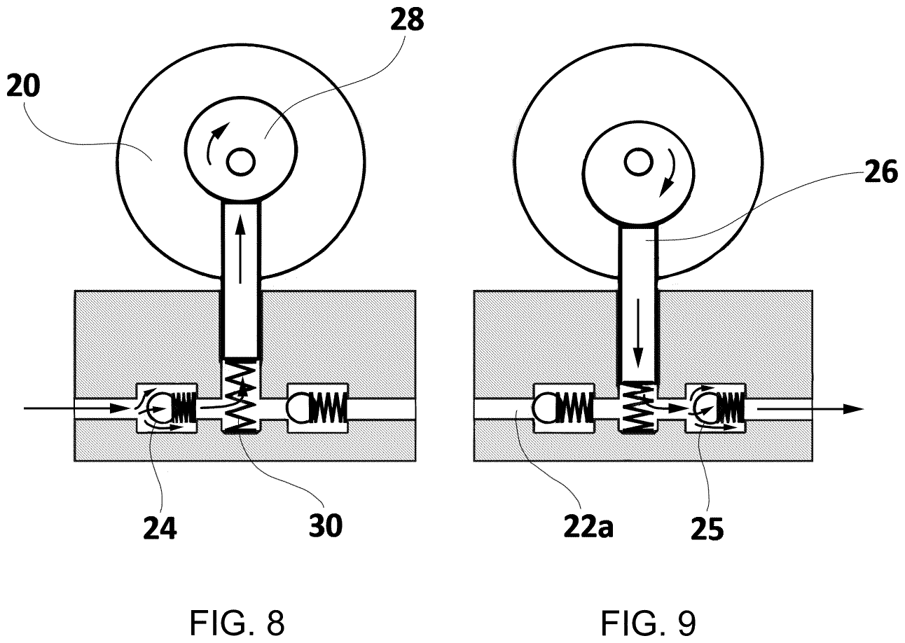

According to an embodiment of the invention (schematically shown in FIGS. 8 and 9), the hydraulic pump 18 comprises a pump piston 26 slidably housed in a volume arranged transversely to the delivery duct 22a and in fluid communication with the latter in a position intermediate between the one-way valves 24, 25.

The pump piston 26 is movable from a retracted position, distal from the delivery duct 22a, to an advanced position, proximal to the delivery duct 22a, the one-way intake and exhaust valves 24, 25 being configured to be open and closed, respectively, in response to the pump piston 26 being moved towards said retracted position, and being configured to be closed and open, respectively, in response to the pump piston 26 being moved towards said advanced position.

Conveniently, the hydraulic pump 18 may comprise an eccentric cam 28, rotatable by means of the electric motor 20 and contacting the pump piston 26 in such a way that the latter moves between the retracted and advanced positions following the cam profile of said eccentric cam 28, the pump piston 26 being kept in contact with the eccentric cam 28 by means of a pump return spring 30.

According to a preferred embodiment, the parking brake actuator 9 comprises a pre-load spring 16, housed within the upper chamber 11a of the actuator cylinder 10 and configured for exerting on the piston 12 a thrust adapted to take up a free play between said end of the actuation pushrod 14 (projecting outside of the actuator cylinder 10) and said release mechanism 15 of vehicle brake. Accordingly, a time delay between the actuation pushrod 14 being pressed outwardly of the actuator cylinder 10 and the release mechanism 15 being operated is reduced or avoided.

The parking brake system may further comprise a return duct 22b, hydraulically connecting the upper chamber 11a of the actuator cylinder 10 to the hydraulic reservoir 22. Conveniently, the return duct 22b branches off from the delivery duct 22a downstream of the exhaust valve 25, so as to bypass the exhaust valve 25.

The parking brake system may further comprise a solenoid valve 32 acting on such return duct 22b, conveniently a conventional two-way solenoid valve, well known in the art. The solenoid valve 32 is switchable from an open position, allowing the fluid to pass from the upper chamber 11a of the actuator cylinder 10 to the hydraulic reservoir 22 through the return duct 22b, to a closed position, preventing the fluid to pass from such upper chamber 11a to the hydraulic reservoir 22 through the return duct 22b.

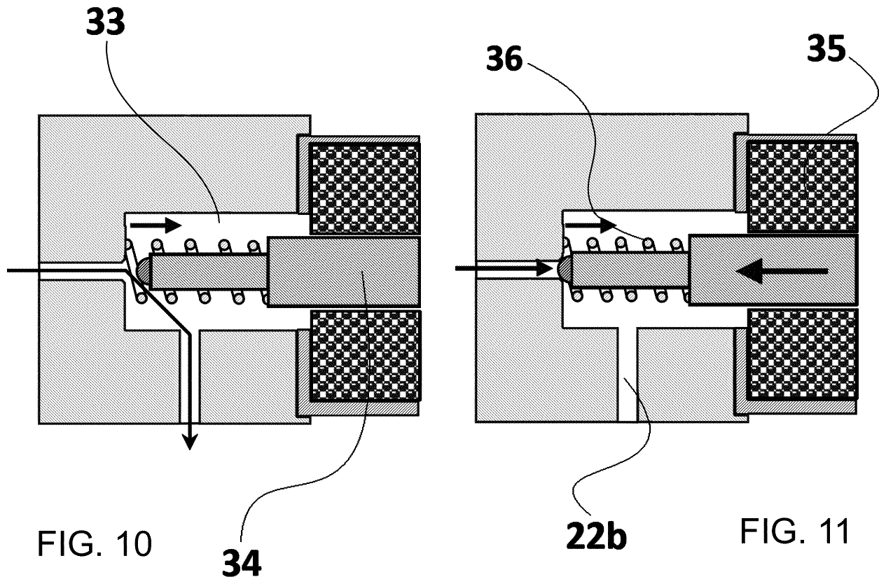

According to an embodiment (schematically shown in FIGS. 10 and 11), the solenoid valve 32 comprises a body defining a cavity 33 and two passages, which hydraulically connect said cavity 33 to the return duct 22b upstream and downstream of the solenoid valve 32, respectively. The solenoid valve 32 further comprises a plunger 34, slidably housed within the cavity 33 and having a rounded tip adapted to occlude the passage upstream of the solenoid valve 32, such plunger 34 being movable from a passive configuration, wherein the rounded tip thereof avoids to close the passage upstream of the solenoid valve 32, so that such passage is in fluid communication with the passage downstream of the solenoid valve 32 via the cavity 33, to an active configuration, wherein the rounded tip of the plunger 34 occlude the passage upstream of the solenoid valve 32, so that a fluid communication between the passages upstream and downstream of the solenoid valve 32 via the cavity 33 is prevented. The plunger 34 is movable towards the active configuration in response to the excitation of a solenoid 35 and towards the passive configuration by means of a return spring 36.

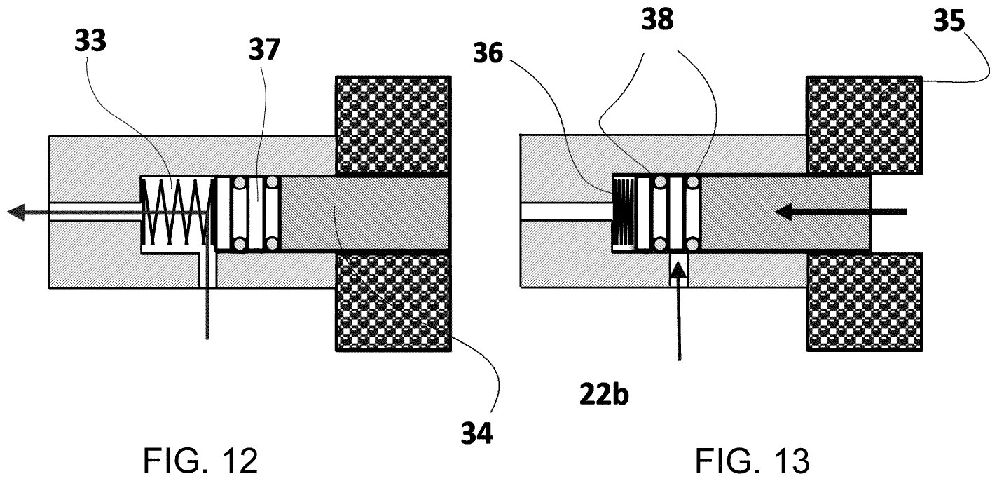

According to an alternative embodiment (schematically shown in FIGS. 12 and 13), the solenoid valve 32 comprises a body defining a cavity 33 and two passages, hydraulically connecting said cavity 33 to the return duct 22b upstream and downstream of the solenoid valve 32, respectively. The solenoid valve 32 further comprises a plunger 34, slidably housed within the cavity 33 and having a section 37 intermediate between two hydraulic seals 38, adapted to seal the plunger 34 against the cavity 33, said plunger 34 being movable from a passive configuration, wherein said section 37 intermediate between two hydraulic seals 38 is not aligned to the passage downstream of the solenoid valve 32, so that such passage is in fluid communication with the passage upstream of the solenoid valve 32 via the cavity 33, to an active configuration, wherein said section 37 intermediate between two hydraulic seals 38 is aligned to the passage downstream of the solenoid valve 32 and occludes the latter, in such a way as to avoid a fluid communication between said passage downstream of the solenoid valve 32 and the passage upstream of the solenoid valve 32 via the cavity 33. The plunger 34 is movable towards the active configuration in response to the excitation of a solenoid 35 and towards the passive configuration by means of a return spring 36.

According to an embodiment, the parking brake system comprises a needle valve 40 of a known type, which is manually operable for closing the return duct 22b.

According to an embodiment, the parking brake system comprises a recirculation duct 22c, hydraulically connecting the lower chamber 11b to the hydraulic reservoir 22. The recirculation duct 22c is particularly useful for avoiding leakages of working fluid during long stays of the vehicle, due to the high pressure the fluid is maintained to. In particular, such recirculation duct 22c may be intended to convey a fluid leaking from (or within) the actuator cylinder 10 (e.g., from the upper chamber 11a to the lower chamber 11b) to the reservoir 22.

According to an embodiment, the parking brake system comprises a pressure relief valve 42 of a known type, adapted to limit the hydraulic pressure in the delivery duct 22a and/or the return duct 22b and/or the recirculation duct 22c. Preferably, the pressure relief valve 42 is mounted on a branch hydraulically connecting the delivery duct 22a, the return duct 22b and the recirculation duct 22c to each other.

According to an embodiment, the parking brake system comprise a pressure relief valve 42 incorporated into the piston 12, such pressure relief valve 42 being adapted to adjust the hydraulic pressure within the upper chamber 11a, in such a way as to allow the fluid to pass from the upper chamber 11a to the lower chamber 11b upon reaching a predetermined pressure within the upper chamber 11a.

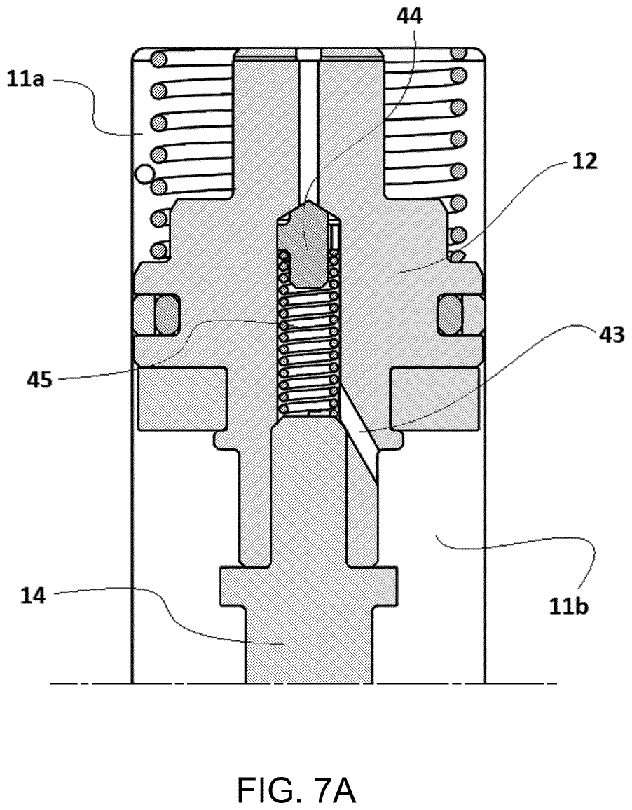

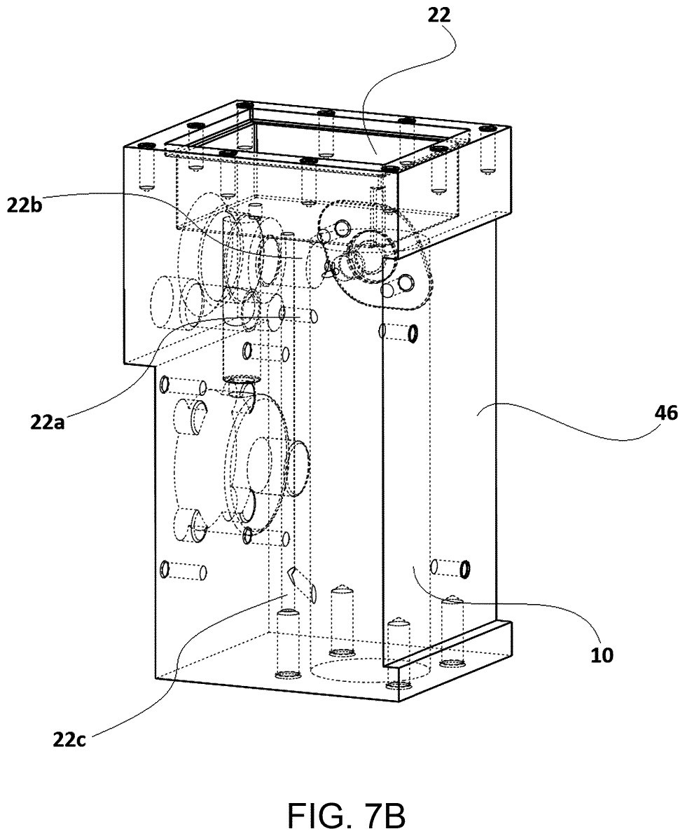

FIG. 7A shows an embodiment of a pressure relief valve 42 incorporated into the piston 12, wherein the piston 12 has an internal duct 43 hydraulically connecting the upper chamber 11a to the lower chamber 11b, such pressure relief valve 42 comprising a shutter 44 slidably housed within the internal duct 43. The shutter 44 is arranged to be movable against the force of an elastic means 45, in response to a hydraulic pressure applied on the shutter 44 by the fluid contained within the upper chamber 11a, upon such hydraulic pressure reaching a predetermined value (dependent on the biasing force exerted by the elastic means 45). The shutter 44 is movable from a closing position, wherein it closes the passage section of the internal duct 43 and a fluid communication between the upper chamber 11a to the lower chamber 11b is prevented, to an opening position, wherein the passage section of the internal duct 43 is at least partially open and a fluid communication between the upper chamber 11a to the lower chamber 11b is allowed.

Preferably, the parking brake system comprises a main body 46, housing the actuator cylinder 10 and/or the delivery duct 22a and/or the return duct 22b and/or the recirculation duct 22c.

According to an embodiment, the parking brake system comprises a position sensor 48, adapted to detect the position of the piston 12 within the actuator cylinder 10.

The position sensor 48 may be a magnetic sensor mounted on the main body 46. Conveniently, the position sensor 48 is housed in a recess on the main body 46 beside the actuator cylinder 10. The parking brake system may further comprise a magnet 49 housed within the actuator cylinder 10 and movable integrally with the piston 12, the position sensor 48 being adapted to detect the axial position of the magnet 49 within the actuator cylinder 10. Conveniently, at least the portion of the main body 46 interposed between the position sensor 48 and the magnet 49 is made of a magnetically transparent material, e.g. Aluminum.

According to an aspect of the invention, a parking brake comprises a parking brake system according to any one of the embodiments disclosed above, and a multidisc brake 50, comprising at least a fixed disc, a mobile disc, a shaft 51, and a locking plate 52, adapted to press on the fixed and mobile discs by means of a spring 54 (e.g., a traditional Belleville spring) in such a way as to immobilize the shaft 51. The parking brake further comprises a leverage 56, operatively connected to the locking plate 52 and the actuation pushrod 14, said leverage 54 being configured in such a way that a force is applied on the locking plate 52 against the force exerted by the spring 54 in response to the actuation pushrod 14 exiting from the actuator cylinder 10, up to the fixed and mobile discs of the multidisc brake 50 being disengaged and the shaft 51 being no longer immobilized. The release mechanism 15 comprises the locking plate 52, the spring 54 and the leverage 56.

Preferably, the leverage 56 comprises a lever having one end adapted to be engaged by the actuation pushrod 14 and the opposite end adapted to engage the locking plate 52, said lever being hinged to a support (not shown), fixed with respect to the locking plate 52, at an intermediate point between said two ends thereof. Accordingly, when the pushrod 14 travels outside of the actuator cylinder 10, the lever 56 is pivoted around the hinge point thereof, thus engaging the locking plate 52 and pushing the latter against the action by the spring 54.

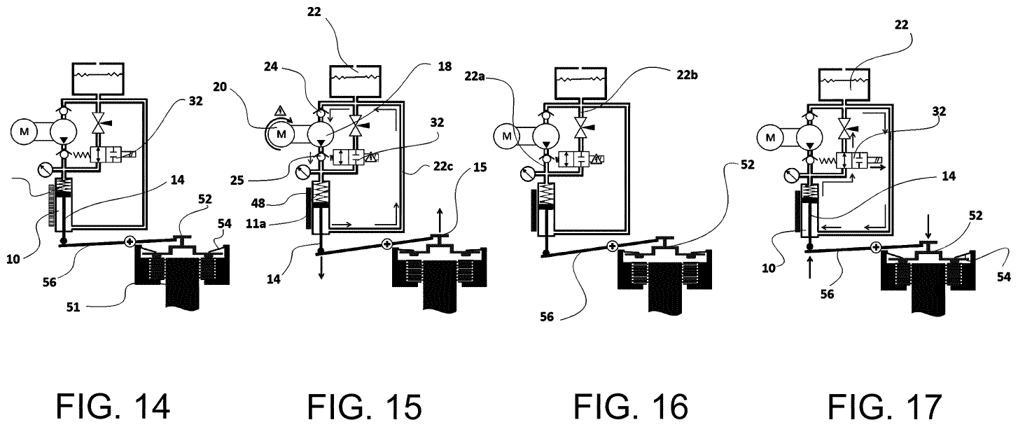

A possible releasing mode of a parking brake will be discussed below. Reference is made to FIGS. 14 to 17, showing a sequence of operating steps of a parking brake system acting on a release mechanism associated to a multidisc brake, according to an embodiment of the invention.

In particular, FIG. 14 shows the system at rest. In this configuration, the solenoid valve 32 is open, and there is no pressure in the hydraulic system. The pre-load spring 16 pushes the release lever 56 by means of the pushrod 14 with a relatively small force which takes up all free-play in the release mechanism 15, and the parking brake is engaged.

Once the brake is requested to release, the solenoid 35 is energized and the solenoid valve 32 switches to the closed configuration (see FIG. 15). The motor 20 is energised and operates the hydraulic pump 18. The hydraulic system is pressurised and the pushrod 14 extends and operates the release lever 56, which in turn engages the locking plate 52. The fluid is pushed out of the lower chamber 11b of the hydraulic cylinder 10 (low pressure side) and recirculated into the system via the recirculation duct 22c and the delivery duct 22a.

The intake and exhaust valves 24, 25 allow the fluid to pass through the delivery duct 22a into the upper chamber of the hydraulic cylinder 10 (high pressure side). The parking brake is releasing.

Once the brake has reached the fully released position, the travel sensor 48 senses that the pushrod 14 has reached the desired release stroke. The motor 20 switches off and the hydraulic pump 18 stops. The solenoid 35 remains energized, keeping the solenoid valve 32 closed. The pressure in the release system is maintained so that the pushrod 14 cannot move, and the parking brake is held in the released position (see FIG. 16).

Once the system is no longer requested to release and the brake has to return to the engaged position, or a system failure occurs and power is lost, the solenoid 35 is de-energised, and the return spring 36 within the solenoid valve 32 opens the port, allowing the fluid to pass through the return duct 22b. The hydraulic system can no-longer maintain any pressure, because the system is connected to atmospheric pressure in the reservoir 22 via the 2-way solenoid valve 32. The spring 54 within the release mechanism 15 pushes against the pushrod 14 via the lever 56, and the fluid flows out of upper chamber 11a of the hydraulic cylinder on the high pressure side. The fluid is recirculated into the low pressure side of the hydraulic cylinder. The parking brake engages and the vehicle cannot move.

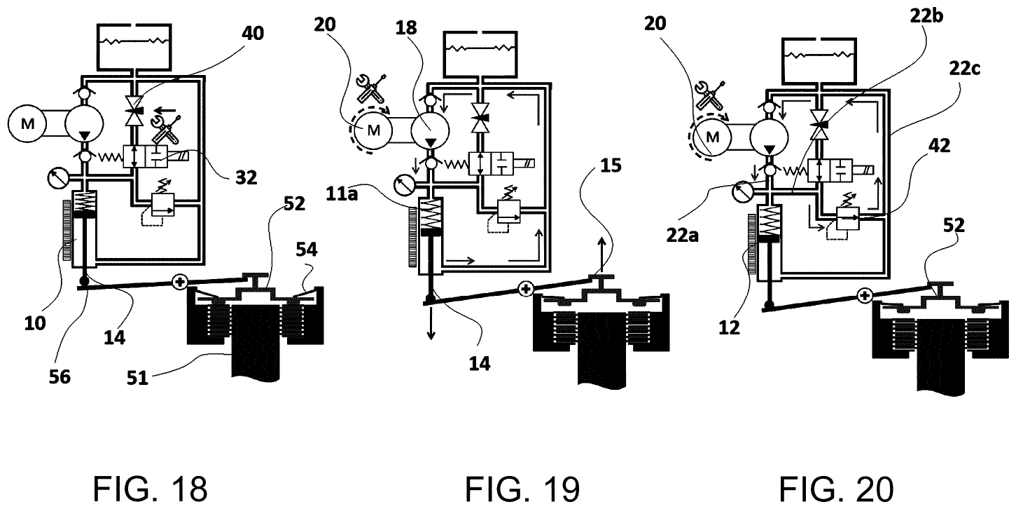

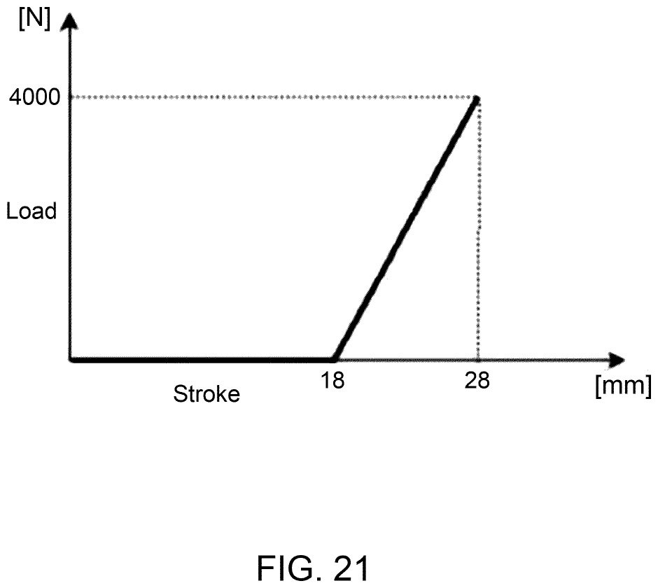

Another possible releasing mode of a parking brake will be discussed below. Reference is made to FIGS. 18 to 20, showing a sequence of operating steps of a parking brake system acting on a release mechanism associated to a multidisc brake, according to an embodiment of the invention.

In particular, FIG. 18 shows a state of the system wherein no power is available for operating the hydraulic pump 18, e.g. in the event of a power/software failure, and the customer requires the brake to be opened. The needle valve 40 is manually closed with a service tool to disconnect the exhaust side of the pump 18 from the reservoir 22. Then, the motor 20 is externally driven, using a service tool. The hydraulic system is pressurised and the pushrod 14 extends and operates the release lever 56, which in turn engages the locking plate 52. The fluid is pushed out of the lower chamber 11b of the hydraulic cylinder 10 (low pressure side) and recirculated into the system via the recirculation duct 22c and the delivery duct 22a. The parking brake is releasing (see FIG. 19).

If the service tool is used to keep turning the pump 18 after the brake has opened, pressure will continue to build, and an overload may occur. In this case, the pressure relief valve 42 prevents excessive system pressure by venting the high pressure fluid at a defined overload pressure, allowing the fluid to bypass the delivery and return ducts 22a, 22b and flow into the recirculation duct 22c.

An example of a force vs. travel characteristic for the lever 56 is shown in FIG. 21.

The parking brake actuator and system described above, in particular by using a combination of an electrically driven pump, a hydraulic cylinder and a solenoid operated valve, gives several advantages, particularly over a positional actuator (where there is a fixed mechanical link between an electric motor and a linearly sliding component).

Indeed, the presence of the hydraulic actuator cylinder allows actuation over a long stroke (e.g., 50 mm) in a compact package.

Moreover, the hydraulic pump is a simple and efficient way to convert from rotational motion at the motor to linear motion at the cylinder. The hydraulic pump also allows to have a very high effective gear ratio between the motor and the cylinder. Due to the long time allowed (e.g., <2.5 s) for brake release, this allows a very low motor power and torque. This high ratio is difficult to achieve using a mechanical mechanism.

Furthermore, the hydraulic circuit can be arranged so that the motor may be switched off when the brake has been disengaged, which enhances electrical efficiency. Also, the hydraulic circuit can be arranged so that the brake engages automatically if electrical power is lost to the actuator.

With a system according to the invention, there is no need for positional control of the actuator, which requires complex motor control. The releasing/engaging of the brake can be achieved by a simple sequence of switching on and off the motor and solenoid. Such lack of control requirement and low power allow to use of a low cost brush DC motor.

Various aspects and embodiments of a parking brake actuator and system according to the invention have been described. It is understood that each embodiment may be combined with any other embodiment. Furthermore, the invention is not limited to the described embodiments, but may be varied within the scope defined by the appended claims.

1. A parking brake system for vehicles, in particular heavy-duty vehicles, comprising:
a parking brake actuator including:
an actuator cylinder;
a piston, which is slidably housed within the actuator cylinder and divides an internal volume of said actuator cylinder into an upper chamber in fluid communication with an exterior of the actuator cylinder, and a lower chamber, the piston being axially slidable within the actuator cylinder in response to a flow of fluid entering into the upper chamber; and
an actuation pushrod slidably housed within the lower chamber of the actuator cylinder, said actuation pushrod being integrally connected to the piston and having an end projecting outside of the actuator cylinder, said end of the actuation pushrod being adapted to act on a release mechanism of a vehicle brake for unlocking said vehicle brake;
the parking brake system further comprising a hydraulic pump operated by an electric motor, said hydraulic pump being adapted to deliver a flow of fluid into the upper chamber for moving the piston within the actuator cylinder.

2. The parking brake system of claim 1, further comprising a hydraulic reservoir, adapted to contain a working fluid to be delivered into the actuator cylinder, and a delivery duct, which that puts in fluid communication said hydraulic reservoir with the upper chamber of the actuator cylinder, wherein an outlet section of the hydraulic pump is hydraulically connected to said delivery duct downstream of the hydraulic reservoir, the parking brake system still further comprising a one-way intake valve and a one-way exhaust valve, placed on the delivery duct upstream and downstream of the outlet section of the hydraulic pump, respectively, and arranged for allowing a fluid to flow only from the hydraulic reservoir to the upper chamber of the actuator cylinder when the hydraulic pump is operated.

3. The parking brake system of claim 1, further comprising a return duct hydraulically connecting the upper chamber of the actuator cylinder to the hydraulic reservoir, the parking brake system still further comprising a solenoid valve acting on the return duct, said solenoid valve being switchable from an open position, allowing the fluid to pass from the upper chamber of the actuator cylinder to the hydraulic reservoir through the return duct, to a closed position, preventing the fluid to pass from the upper chamber of the actuator cylinder to the hydraulic reservoir through the return duct.

4. The parking brake system of claim 3, wherein the solenoid valve comprises a body defining a cavity and two passages, hydraulically connecting said cavity to the return duct upstream and downstream of the solenoid valve, respectively, said solenoid valve further comprising a plunger slidably housed within the cavity and having a rounded tip adapted to occlude the passage upstream of the solenoid valve, said plunger being movable from a passive configuration, in which the rounded tip of the plunger avoids to close the passage upstream of the solenoid valve, which is in fluid communication with the passage downstream of the solenoid valve via the cavity, to an active configuration, in which the rounded tip of the plunger occludes the passage upstream of the solenoid valve, the plunger being movable towards the active configuration in response to excitation of a solenoid and towards the passive configuration by a return spring.

5. The parking brake system of claim 3, wherein the solenoid valve comprises a body defining a cavity and two passages, hydraulically connecting said cavity to the return duct upstream and downstream of the solenoid valve, respectively, said solenoid valve further comprising a plunger slidably housed within the cavity and having a section intermediate between two hydraulic seals, adapted to seal the plunger against the cavity, said plunger being movable from a passive configuration, in which said section intermediate between the two hydraulic seals is not aligned to the passage downstream of the solenoid valve, which is in fluid communication with the passage upstream of the solenoid valve via the cavity, to an active configuration, in which said section intermediate between the two hydraulic seals is aligned to the passage downstream of the solenoid valve and occludes the passage downstream of the solenoid valve to avoid fluid communication between said passage downstream of the solenoid valve and the passage upstream of the solenoid valve, the plunger being movable towards the active configuration in response to excitation of a solenoid p and towards the passive configuration by a return spring.

6. The parking brake system of claim 3, further comprising a recirculation duct hydraulically connecting the lower chamber to the hydraulic reservoir.

7. The parking brake system of claim 3, further comprising a needle valve manually operable for closing the return duct.

8. The parking brake system of claim 6, further comprising a pressure relief valve 7 adapted to limit a hydraulic pressure in at least one of the delivery duct, the return duct, and the recirculation duct.

9. The parking brake system of claim 1, further comprising a pressure relief valve incorporated into the piston, said pressure relief valve being adapted to adjust a hydraulic pressure within the upper chamber, so as to allow a fluid to pass from the upper chamber to the lower chamber upon reaching a predetermined pressure within the upper chamber.

10. The parking brake system of claim 9, wherein the piston comprises an internal duct hydraulically connecting the upper chamber to the lower chamber, and wherein the pressure relief valve comprises a shutter slidably housed within the internal duct being arranged to be movable against a force of an elastic means in response to a hydraulic pressure applied on the shutter M by the fluid contained within the upper chamber, upon such hydraulic pressure reaching a predetermined value, the shutter being movable from a closing position, in which the shutter closes a passage section of the internal duct and fluid communication between the upper chamber to the lower chamber is prevented, to an opening position, in which the passage section of the internal duct is at least partially open and fluid communication between the upper chamber to the lower chamber is allowed.

11. The parking brake system of claim 6, further comprising a main body T housing at least one of the actuator cylinder, the delivery duct, the return duct, and the recirculation duct.

12. A parking brake, comprising:
a parking brake system comprising:
a parking brake actuator including:
an actuator cylinder;
a piston, which is slidably housed within the actuator cylinder and divides an internal volume of said actuator cylinder into an upper chamber in fluid communication with an exterior of the actuator cylinder, and a lower chamber, the piston being axially slidable within the actuator cylinder in response to a flow of fluid entering into the upper chamber; and
an actuation pushrod slidably housed within the lower chamber of the actuator cylinder, said actuation pushrod being integrally connected to the piston and having an end projecting outside of the actuator cylinder, said end of the actuation pushrod being adapted to act on a release mechanism of a vehicle brake for unlocking said vehicle brake;
the parking brake system further comprising a hydraulic pump operated by an electric motor, said hydraulic pump being adapted to deliver a flow of fluid into the upper chamber for moving the piston within the actuator cylinder;
a multidisc brake, comprising at least a fixed disc, a mobile disc, a shaft, and a locking plate, adapted to press on the fixed and mobile discs by moans of a spring in such a way as to immobilize the shaft; and
a leverage, operatively connected to the locking plate and the actuation pushrod, said leverage being configured in such a way that a force is applied on the locking plate against the spring in response to the actuation pushrod exiting from the actuator cylinder, up to until the fixed and mobile discs of the multidisc brake being are disengaged and the shaft being is no longer immobilized.

13. The parking brake of claim 12, wherein the leverage comprises a lever having one end adapted to be engaged by the actuation pushrod and an opposite end adapted to engage the locking plate, said lever being hinged to a support, fixed with respect to the locking plate, at an intermediate point between said ends of the lever.
